(19) United States
(12) Patent Application Publication
(10) Pub. No.: US 2025/0357875 A1
(43) Pub. Date: Nov. 20, 2025

(54) METHOD FOR ESTIMATING ROTATIONAL INERTIA OF AN ELECTRIC MOTOR AND LOAD SYSTEM AND ELECTRIC MOTOR FOR EXECUTING SAID METHOD

(71) Applicant: Danfoss Power Electronics A/S, Gråsten (DK)

(72) Inventors: Peter Scavenius Andersen, Sønderborg (DK); Klaus Jensen, Sønderborg (DK)

(21) Appl. No.: 19/203,704

(22) Filed: May 9, 2025

(30) Foreign Application Priority Data
May 14, 2024 (DE) 102024113506.9

(51) Int. Cl. H02P 21/14

(52) U.S. Cl. CPC H02P 21/14

(57) ABSTRACT

The present disclosure pertains to a method for estimating rotational inertia of an electric motor and load system during normal operation and invariant load characteristics of the system. The method includes the steps of operating the electric motor via an electric motor drive in a normal operation mode with invariant load characteristics; estimating instantaneous mechanical power; calculating the difference in power integrals during speed ramp-up and ramp-down of the electric motor, wherein the speed ramp-up and ramp-down correspond to transients and/or perturbations; and calculating rotational inertia from the measured power difference integrals. The disclosure also pertains to an electric motor drive provided for executing said method.

### CROSS-REFERENCE TO RELATED APPLICATIONS

This application claims foreign priority benefits under 35 U.S.C. § 119 to German Patent Application No. 102024113506.9 filed on May 14, 2024, the content of which is hereby incorporated by reference in its entirety.

### TECHNICAL FIELD

The present invention pertains to a method for estimating rotational inertia of an electric motor and load system during normal operation and invariant load characteristics of the system.

The invention also pertains to an electric motor drive provided for executing said method.

### BACKGROUND

When operating electric motor and load systems, the rotational inertia of the system may be determined for allowing dynamic performance optimization of the system. The rotational inertia may also be used for condition monitoring of an application connected to the system. The rotational inertia of the system may refer to the combined inertias of the motor and its load.

Known methods for providing rotational inertia estimations of electric motor and load systems typically rely on an accurate torque estimation, which in return requires precise motor data. Furthermore, most known methods rely on a dedicated run sequence which cannot be tolerated in applications, in which uninterrupted normal operation of the system is essential.

As a result, these known inertia estimation methods require rather comprehensive hardware systems, can be time consuming and prone to inaccuracies in system parameter. Furthermore, known inertia estimation methods may necessitate detrimental system shutdowns during their execution.

### SUMMARY

The aim of the present invention is to overcome these problems by providing an improved method for estimating rotational inertia of an electric motor and load system and a corresponding electric motor drive. Preferable embodiments of the invention are subject to the dependent claims.

According to claim 1, a method for estimating rotational inertia of an electric motor and load system during normal operation and invariant load characteristics of the system is provided. The method comprises the steps of
operating the electric motor via an electric motor drive in a normal operation mode with time invariant load characteristics;
estimating instantaneous mechanical power;
calculating the difference in power integrals during speed ramp-up and ramp-down of the electric motor, wherein the speed ramp-up and ramp-down correspond to transients and/or perturbations; and
calculating rotational inertia from the measured power difference integrals.

According to the method, the drive output power or instantaneous mechanical power of the motor is measured and integrated during a speed increase and decrease of the motor. As the motor load is kept a time invariant function of speed, the difference of the integrals represents the rotational energy of the system. From this, the inertia is calculated.

The presently described method makes it possible to use either a naturally occurring or provoked speed change in the system, wherein the motor speeds and power are used to determine inertia.

The method is independent of the type of motor, load independent, control core independent, and can be used while the system is in normal operation. Furthermore, the method does not rely on the availability of precise motor parameters.

In another preferred embodiment of the invention, the rotational inertia is calculated from equation (2.19)

$$J = \frac{2 Δ {E}_{mech}}{{ω}_{1}^{2} - {ω}_{0}^{2}}$$

wherein ΔE_{mech} is calculated from equation (2.18)

$$Δ {E}_{mech} = \frac{- x {E}_{1} + {E}_{2}}{- 1 - x} = \frac{x {E}_{1} - {E}_{2}}{1 + x}$$

wherein x describing the proportion of ramp-down to ramp-up durations is defined in equation (2.15)

$$x = \frac{{t}_{3} - {t}_{2}}{{t}_{1} - {t}_{0}}$$

and wherein E1 and E2 are calculated from equations (2.11)

$${E}_{1} = {\int }_{{t}_{0}}^{{t}_{1}} p ( t ) dt$$

$${E}_{2} = {\int }_{{t}_{2}}^{{t}_{3}} p ( t ) dt$$

In another preferred embodiment of the invention, the speed ramp-up and ramp-down correspond to the overshoot transient during the ramping up of the electric motor to a reference speed, if the overshoot transient has sufficiently long duration. The overshoot needs to be long enough for the motor drive executing the method to collect sufficient data for calculating the power integrals.

In another preferred embodiment of the invention, estimating instantaneous mechanical power comprises measuring electric motor drive output and subtracting estimated electric motor losses.

In another preferred embodiment of the invention, increasing and decreasing speeds of the electric motor comprises superimposing a preferably symmetric speed ramp-up and ramp-down sequence on the electric motor speed in its normal operation mode, wherein preferably the electric motor speed in its normal operation mode is a steady speed. The resulting motor speed once the speed ramp-up and ramp-down sequence have been superimposed is clearly no longer steady. However, the speed ramp-up and ramp-down sequence may be selected such that the operation driven by the motor is not interrupted.

In another preferred embodiment of the invention, the speed ramp-up is performed before or after the speed ramp-down.

In another preferred embodiment of the invention, the method is performed once after each start-up of the electric motor and/or periodically at a configurable time interval.

The invention also pertains to an electric motor drive provided for executing the presently described method.

### BRIEF DESCRIPTION OF THE DRAWINGS

Further advantages and details of the invention are described with reference to the embodiments shown in the figures, wherein features of various embodiments may be combined in any logically possible manner within the scope of the invention. The figures show:

FIG. 1: graph indicating speed and power of the motor against time;

FIG. 2: circuit diagram indicating current flows through motor stator and rotor indicating losses;

FIG. 3: graph indicating motor ramp up with reference speed and actual speed;

FIG. 4: graphs indicating motor overshoot transients simulation for inertia estimation;

FIG. 5: graph indicating motor speed perturbation with reference speed and actual speed; and

FIG. 6: graphs indicating motor speed perturbation simulation for inertia estimation.

### DETAILED DESCRIPTION

In this description, the following nomenclature will be used:

T=torque

t=time

J=rotational inertia

ω=mechanical speed

p=instantaneous power

E=energy

W=work (load consumed energy)

x=ratio

u/U, i/I=voltage, current

R=resistance

As a starting point, the familiar law of motion of rotational elements is equation (2.1)

$${T}_{acc} = {T}_{m} - {τ}_{l} = J \frac{d ω}{d t}$$

The load can be an arbitrary function of speed, described by equation (2.2)

$${T}_{l} = {f}_{l} ( ω )$$

and can take on a constant, quadratic or other relation with speed, or be considered zero. The instantaneous mechanical power of the rotating system during an acceleration is given by equation (2.3)

$$p ( t ) = {T}_{m} ( t ) ω ( t ) = ( {T}_{acc} ( t ) + {T}_{l} ( t ) ) ω ( t ) = ( {T}_{acc} ( t ) + {f}_{l} ( ω ( t ) ) ) ω ( t )$$

This power can be estimated relatively precisely, since the drive output power is measured, and the motor losses can be estimated.

Integrating the power over a given time span yields an energy that is given by equation (2.4)

$${E}_{1} = {\int }_{{t}_{0}}^{{t}_{1}} p ( t ) dt = {\int }_{{t}_{0}}^{{t}_{1}} {T}_{acc} ( t ) ω ( t ) dt + {\int }_{{t}_{0}}^{{t}_{1}} {f}_{1} ( ω ( t ) ) ω ( t ) dt$$

The energy is seen to contain two parts: A change in energy in the rotating system provided by T_{acc}, and the energy consumed by the load during that period. If no acceleration takes place, obviously the energy stored in the rotating system remains constant as the first integral is zero.

In the following, different speed variation techniques used for estimation are investigated.

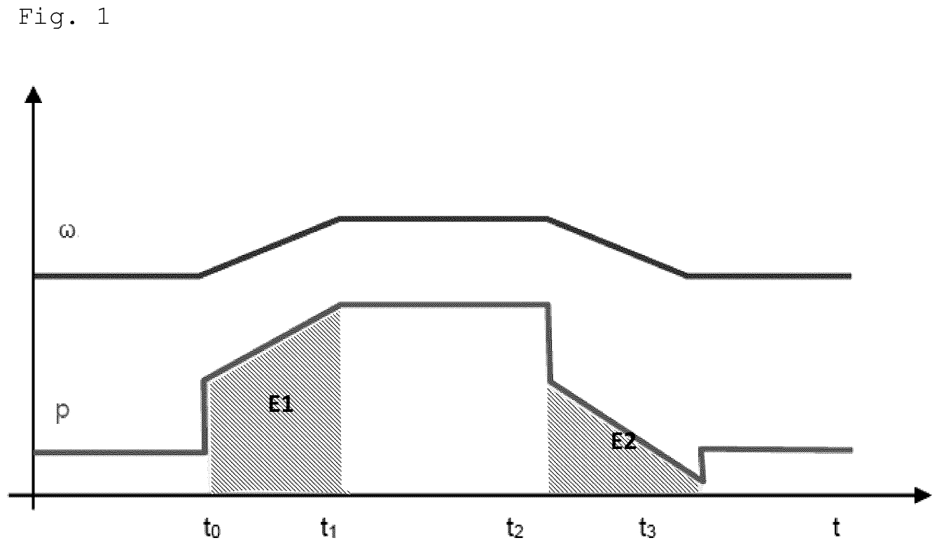

In a first embodiment of the invention, an identical speed ramp up and ramp down sequence is applied as shown in FIG. 1. This sequence may be superimposed on the existing operating (steady state) speed and thus be considered a small signal.

The power integrals are performed in each ramp sequence, and since the speed profiles are opposite but otherwise symmetric, the difference between the two integrals will express the actual acceleration torque, since the load energies are assumed identical and therefore cancel each other according to equation (2.5):

$$Δ E = {\int }_{{t}_{0}}^{{t}_{1}} p ( t ) dt - {\int }_{{t}_{2}}^{{t}_{3}} p ( t ) dt = {\int }_{{t}_{0}}^{{t}_{1}} {T}_{acc 1} ( t ) ω ( t ) dt - {\int }_{{t}_{2}}^{{t}_{3}} {T}_{acc 2} ( t ) ω ( t ) dt$$

Expanding on these integrals yields the energy difference between speed ramp sequences according to equation (2.6):

$$Δ E = {[ {T}_{acc 1} ω t ]}_{{t}_{0}}^{{t}_{1}} - {[ - {T}_{acc 2} ω t ]}_{{t}_{2}}^{{t}_{3}}$$

If the speed profiles are symmetric but opposite during the two time sequences, it follows that the two acceleration torques will be equal in magnitude but having opposite signs. The two time spans are equal, so t1−t0=t3−t2=Δt. Consequently, the energy difference simplifies to equation (2.7):

$$Δ E = 2 {T}_{acc} ω Δ t = 2 Δ {E}_{mech}$$

The energy difference ΔE represents 2 times the change in rotational energy when going from start speed to end speed. The speed trajectory in between is in theory not important. Since, in general, rotational energy at constant speed and inertia is given by equation (2.8):

$${E}_{rot} = \frac{1}{2} J {ω}^{2}$$

from combining this with equation (2.7) it must follow (eq. 2.9):

$$Δ E = 2 \frac{1}{2} J ( {ω}_{1}^{2} - {ω}_{0}^{2} ) = J ( {ω}_{1}^{2} - {ω}_{0}^{2} )$$

where ω1 and ω0 are the speeds at the end and the beginning of the perturbation ramp, respectively.

Summarizing the aforementioned points, the rotational inertia can be found from equation (2.10):

$$J = \frac{{\int }_{{t}_{0}}^{{t}_{1}} p ( ω ) dt - {\int }_{{t}_{2}}^{{t}_{3}} p ( ω ) dt}{{ω}_{1}^{2} - {ω}_{0}^{2}}$$

provided that

Δω is the speed difference of both the ramp-up and the ramp-down sequence,

Δt=t1−t0=t3−t2 is the duration of the ramp-up and ramp-down sequence.

the load torque behaviour is considered equal in both ramp sequences, i.e. the load is time invariant.

As long as these conditions hold, the actual speed and acceleration torque dynamics during the ramp sequences are not important.

In another embodiment, a more general case of different ramp-up and ramp-down times is considered, wherein speed differences are equal, according to equation (2.11):

$${E}_{1} = {\int }_{{t}_{0}}^{{t}_{1}} p ( t ) dt = {\int }_{{t}_{0}}^{{t}_{1}} {T}_{acc 1} ( t ) ω ( t ) dt + {\int }_{{t}_{0}}^{{t}_{1}} {f}_{l} ( ω ( t ) ) ω ( t ) dt$$

$${E}_{2} = {\int }_{{t}_{2}}^{{t}_{3}} p ( t ) dt = {\int }_{{t}_{2}}^{{t}_{3}} {T}_{acc 2} ( t ) ω ( t ) dt + {\int }_{{t}_{2}}^{{t}_{3}} {f}_{l} ( ω ( t ) ) ω ( t ) dt$$

In this more generalized case, the acceleration torque is not identical in the two sequences. However, the change of stored mechanical energy must be equal, so even if the acceleration torques are not equal, the associated time difference compensates this.

Moreover, the product of load torque and speed is assumed to be a general load power function p₁(t). Considering all this, the expressions are simplified to equation (2.12):

$${E}_{1} = {\int }_{{t}_{0}}^{{t}_{1}} {p}_{l} ( t ) dt + Δ {E}_{mech} = {W}_{l} ( {t}_{1} ) - {W}_{l} ( {t}_{0} ) + Δ {E}_{mech}$$

$${E}_{2} = {\int }_{{t}_{2}}^{{t}_{3}} {p}_{l} ( t ) dt - Δ {E}_{mech} = {W}_{l} ( {t}_{3} ) - {W}_{l} ( {t}_{2} ) - Δ {E}_{mech}$$

where W₁ is the antiderivative function of the load power function and describes the energy dissipated in the load (or the work done). It can be arbitrary but is assumed time invariant. It is furthermore assumed that due to the time invariance, the difference of equation (2.13)

$$Δ {W}_{l} = {W}_{l} ( t + Δ t ) - {W}_{l} ( t )$$

is proportional to the time difference itself, i.e. equation (2.14)

$${E}_{1} = Δ {W}_{l} + Δ {E}_{mech}$$

$${E}_{2} = x Δ {W}_{l} - Δ {E}_{mech}$$

with x describing the proportion of ramping down to ramping up time intervals, defined in equation (2.15)

$$x = \frac{{t}_{3} - {t}_{2}}{{t}_{1} - {t}_{0}}$$

This would hold for non-oscillating transitions from one speed to another (and back again). Putting equation (2.14) on matrix form yields equation (2.16)

$$[ \begin{matrix}{E}_{1} \\ {E}_{2}\end{matrix} ] = [ \begin{matrix}1 & 1 \\ x & - 1\end{matrix} ] [ \begin{matrix}Δ {W}_{l} \\ Δ {E}_{mech}\end{matrix} ]$$

which can be solved for the vector containing load energy and mechanical energy as shown in equation (2.17)

$$[ \begin{matrix}Δ {W}_{l} \\ Δ {E}_{mech}\end{matrix} ] = \frac{1}{- 1 - x} [ \begin{matrix}- 1 & - 1 \\ - x & 1\end{matrix} ] [ \begin{matrix}{E}_{1} \\ {E}_{2}\end{matrix} ]$$

from which the change in mechanical energy can be calculated according to equation (2.18)

$$Δ {E}_{mech} = \frac{- {xE}_{1} + {E}_{2}}{- 1 - x} = \frac{{xE}_{1} - {E}_{2}}{1 + x}$$

Having thus found the change in mechanical energy, the inertia can be found from the aforementioned formulae, i.e. according to equation (2.19)

$$J = \frac{2 Δ {E}_{mech}}{{{ω}_{1}}^{2} - {{ω}_{0}}^{2}}$$

In the case where ramp up and down times are equal, x=1, and (2.18) becomes identical to (2.7). In other words, the factor x considers the uneven energy magnitudes resulting from uneven integration time intervals caused by uneven ramps.

The inertia estimation relies on the estimation of shaft power which is only known indirectly from measurable electrical output power combined with estimated motor losses according to equation (3.1)

$${P}_{mech} = {P}_{el} - {P}_{loss}$$

Note that power is considered positive when flowing from the drive to the motor. With the losses always being a positive number, the mechanical power is numerically smaller than the electric power in the motoring case.

In the case of generative load, both mechanical and electrical power are negative. Then, from equation (3.1), the mechanical power becomes a numerically larger number than the electrical power which is expected in this case. Thus, equation (3.1) holds in both cases of motoring and generating operation modes.

In dq coordinates, the power is calculated accordingly from equation (3.2)

$${P}_{el} = \frac{3}{2} {{\overline{u}}_{dq}}^{T} {\overline{l}}_{dq}$$

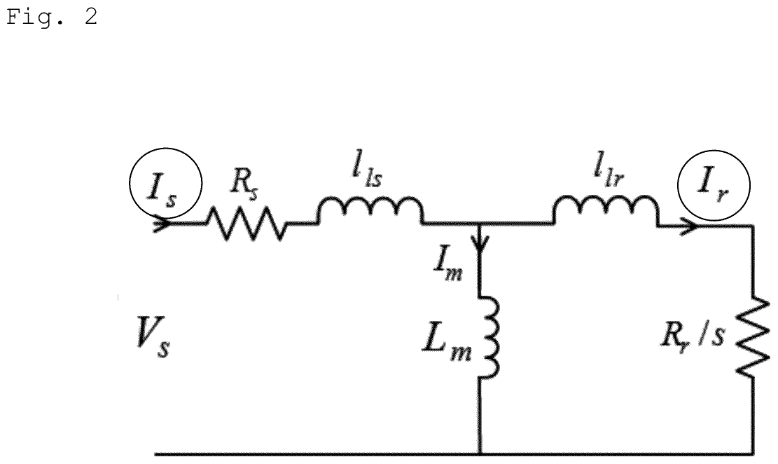

The loss calculation, however, needs some consideration especially for induction motors, for distinguishing between currents which are located in stator and rotor. In FIG. 2, it is shown how stator and rotor currents are used to predict the motor losses. Iron losses are discarded

For synchronous motors, only stator winding losses need to be considered, as again iron losses are discarded. Table 1 summarizes how the motor losses are calculated in each case:

| | Induction motor | Synchronous motor |
|---|---|---|
| Is | Sqrt (id² + iq²) | Sqrt (id² + iq²) |
| Im | id | 0 |
| Ir | iq | 0 |
| P loss, stator | Rs (id² + iq²) | Rs (id² + iq²) |
| P loss, rotor | Rr iq² | 0 |

According to the present invention, inertia can be estimated from a speed increase and decrease sequence. As long as the sequence starts and ends at the same speed, it does not need to be symmetrical, i.e. increasing and decreasing parts need not be identical. In the following, two operation modes for inertia estimation are described.

Speed overshoots often occur in applications where inertia is large and the speed controller is not tuned aggressively. Therefore, the overshoot transient may be used as a speed increase and decrease case, provided it is large enough. A proposal is shown in the following.

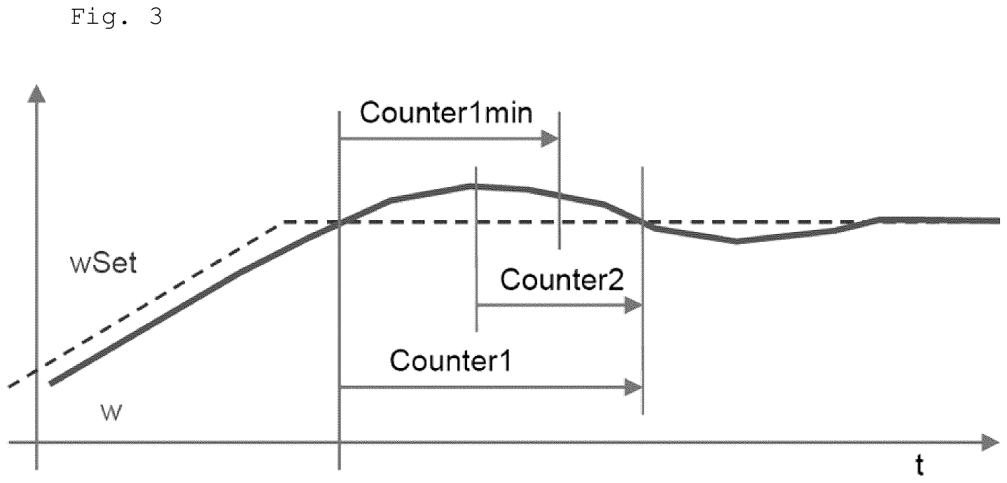

FIG. 3 shows a schematic of motor speed being ramped up according to a reference speed and overshooting. Counter 1 represents the duration of the overshoot transient. If this exceeds a lower threshold value (Counter1min), the transient is large enough to estimate inertia from, and the function terminates when this is done. In this case, the estimation is purely passive.

Counter 2 is initiated when max speed has been detected, and both counter 1 and 2 terminate when speed has decreased to the value at which the counters have started. The difference counter 1−counter 2 is thus the duration of the speed increase, and counter 2 the duration of the decrease.

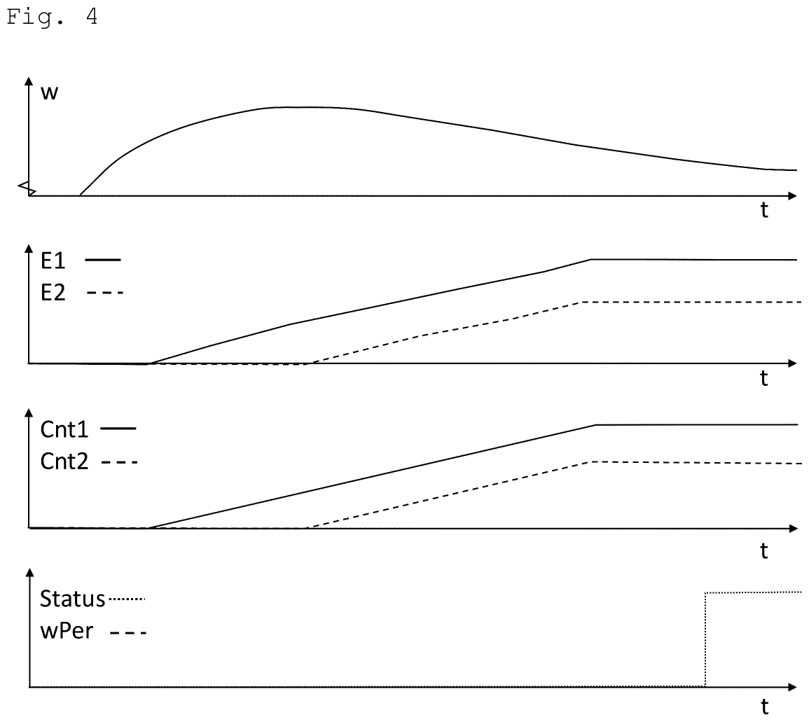

FIG. 4 shows a simulation of an overshoot transient being used for inertia estimation. The top plot shows speed, 2nd from top is power integrators 1 and 2, 3rd from top is counters 1 and 2, and bottom plot is status and perturbation speed output, which in this case is zero since the function in this case is not commanding any speed perturbation.

Note the different speed increase and decrease times which are used to calculating the ratio x as per equation (2.15).

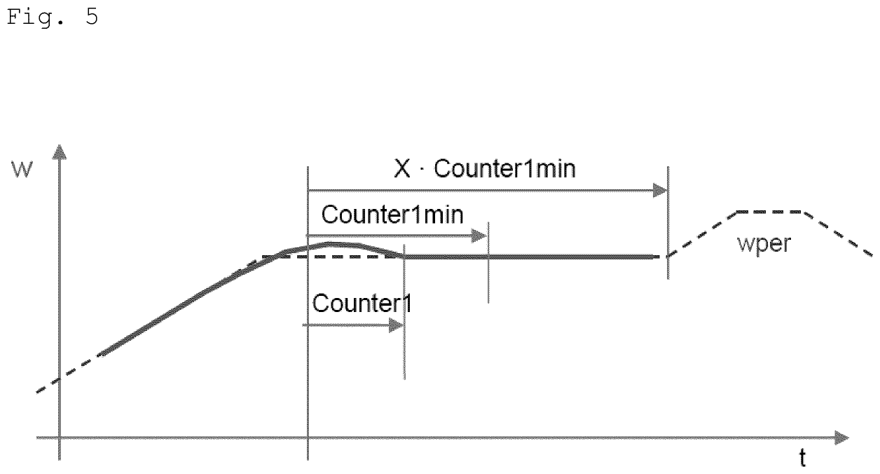

If the transient is too short, or too small to be determined, a ramp output is propagated to be superimposed on the speed reference signal, and inertia is estimated from this perturbation, as shown in FIG. 5.

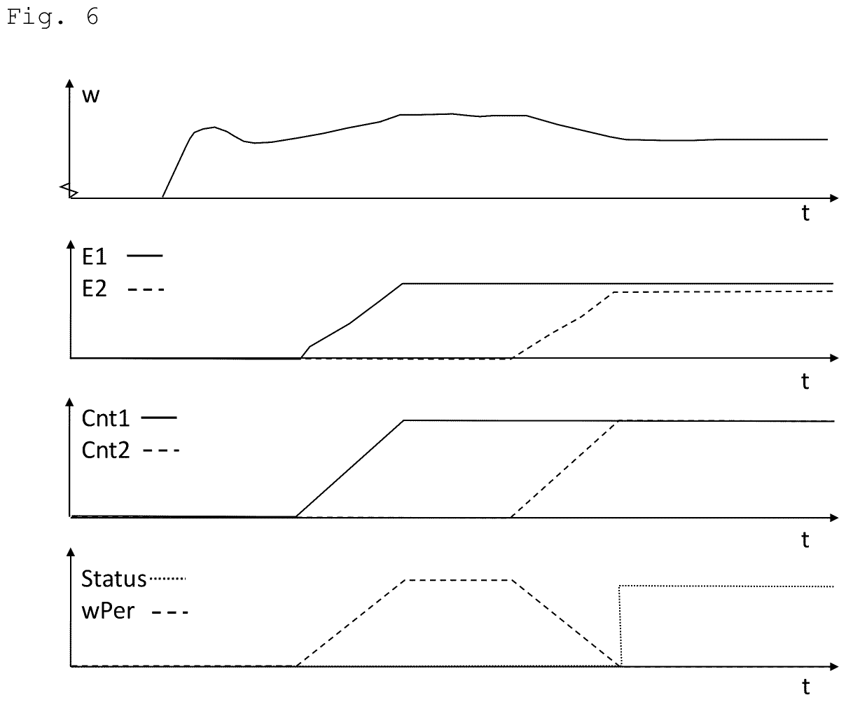

A case of this functionality is shown in FIG. 6. Top plot shows mechanical speed, 2nd from top is power integrators 1 and 2, 3rd from top is counters 1 and 2, and bottom plot is status and electrical perturbation speed output.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A method for estimating rotational inertia of an electric motor and load system during normal operation and invariant load characteristics of the system, comprising the steps of
operating the electric motor via an electric motor drive in a normal operation mode with time invariant load characteristics;
estimating instantaneous mechanical power;
calculating the difference in power integrals during speed ramp-up and ramp-down of the electric motor, wherein the speed ramp-up and ramp-down correspond to transients and/or perturbations; and
calculating rotational inertia from the measured power difference integrals.

2. The method according to claim 1, wherein in that the rotational inertia is calculated from equation (2.19)
$$J = \frac{2 Δ {E}_{mech}}{{{ω}_{1}}^{2} - {{ω}_{0}}^{2}}$$
wherein ΔE_{mech} is calculated from equation (2.18)
$$Δ {E}_{mech} = \frac{- {xE}_{1} + {E}_{2}}{- 1 - x} = \frac{{xE}_{1} - {E}_{2}}{1 + x}$$
wherein x describing the proportion of ramp-down to ramp-up durations is defined in equation (2.15)
$$x = \frac{{t}_{3} - {t}_{2}}{{t}_{1} - {t}_{0}}$$
and wherein E1 and E2 are calculated from equations (2.11))
$${E}_{1} = {\int }_{{t}_{0}}^{{t}_{1}} p ( t ) dt$$
$${E}_{2} = {\int }_{{t}_{2}}^{{t}_{3}} p ( t ) dt$$

3. The method according to claim 1, wherein the speed ramp-up and ramp-down correspond to the overshoot transient during the ramping up of the electric motor to a reference speed, if the overshoot transient has sufficiently long duration.

4. The method according to claim 1, wherein estimating instantaneous mechanical power comprises measuring electric motor drive output and subtracting estimated electric motor losses.

5. The method according to claim 1, wherein increasing and decreasing speeds of the electric motor comprises superimposing a preferably symmetric speed ramp-up and ramp-down sequence on the electric motor speed in its normal operation mode, wherein preferably the electric motor speed in its normal operation mode is a steady speed.

6. The method according to claim 1, wherein the speed ramp-up is performed before or after the speed ramp-down.

7. The method according to claim 1, wherein the method is performed once after each start-up of the electric motor and/or periodically at a configurable time interval.

8. An electric motor drive provided for executing a method according to claim 1.
